(19) United States
(12) Patent Application Publication
(10) Pub. No.: US 2025/0093543 A1
(43) Pub. Date: Mar. 20, 2025

(54) ACOUSTIC SYSTEM FOR DOWNHOLE APPLICATIONS

(71) Applicant: Saudi Arabian Oil Company, Dhahran (SA)

(72) Inventor: Dwight W. Swett, Cypress, TX (US)

(21) Appl. No.: 18/471,037

(22) Filed: Sep. 20, 2023

(51) Int. Cl. G01V 1/46

(52) U.S. Cl. CPC G01V 1/46

(57) ABSTRACT

Systems and a method for acoustic testing in a wellbore are provided. An exemplary acoustic source used in the acoustic testing includes an acoustic metamaterial generated from a geometrical inversion of a set of conformal contours developed from mapping of Tangent Circles, wherein the acoustic metamaterial is anistotropic with a horizontal axis (D_cell) smaller than a vertical axis (R_{xy}*D_cell).

### TECHNICAL FIELD

This disclosure relates to systems and methods of performing acoustic testing in a wellbore using an acoustic metamaterial.

### BACKGROUND

The power of an acoustic source radiated to the far field is proportional to (D/λ)² where D is a dimension characteristic of the size of the source and λ is the wavelength in the fluid medium. Sources with dimensions on the same order of magnitude as the wavelength are required to enhance low frequency acoustic emission, which can translate into more than one meter in size for wellbore seismic applications. This is impracticable considering typical wellbore diameters are less than 200 mm. accordingly, at low frequencies, such as less than about 2 kHz in water, the size of a conventional source is smaller than the wavelength in the fluid. Thus, acoustic emissions downhole are poor at low frequencies using conventional technologies.

Some acoustic devices have been proposed to enhance source emission using acoustic metamaterials. However, proposed devices are designed for an air medium that is more than six orders of magnitude smaller wavelength than in the fluids that need to be addressed for wellbore seismic applications. As the degree of difficulty in amplifying acoustic radiation is directly proportional to the acoustic impedance of the media addressed, these designs for an air media are irrelevant to the downhole borehole fluid media of practical interest for the oilfield.

### SUMMARY

An embodiment described herein provides a sonic logging tool. The sonic logging tool includes an acoustic source that includes an acoustic metamaterial and an acoustic emitter disposed in the center of the metamaterial. The sonic logging tool further includes an acoustic detector that includes a cross-line acoustic receiver array and an in-line acoustic receiver array.

Another embodiment described herein provides a method for performing sonic logging in a wellbore. The method includes placing a sonic logging tool in the wellbore. The sonic logging tool includes an acoustic source that includes an acoustic metamaterial and an acoustic emitter disposed in the center of the metamaterial. The sonic logging tool further includes an acoustic detector that includes a cross-line acoustic receiver array and an in-line acoustic receiver array. The acoustic emitter is energized to emit sound waves and amplified sonic energy is emitted from the metamaterial. Reflected sonic energy from materials outside the wellbore is detected.

Another embodiment described herein provides an acoustic source. The acoustic source includes an acoustic metamaterial generated from a geometrical inversion of a set of conformal contours developed from mapping of Tangent Circles, wherein the acoustic metamaterial is anistotropic with a horizontal axis (D_cell) smaller than a vertical axis (R_{xy}*D_cell).

### BRIEF DESCRIPTION OF DRAWINGS

FIGS. 1A-1D are drawings of a sonic logging tool using a dipole source.

FIGS. 2A-2C are plots of acoustic source radiation patterns that can be created in examples described herein.

FIGS. 3A-3C are illustrations of the sonic logging tool showing quadrupole and dipole acoustic radiation patterns to image materials, such as a formation, outside a wellbore.

FIGS. 4A-4D are plots of geometric inversions of Tangent Circles conformal mapping contours that is used to develop metamaterials that have a strong absorption of vibrational energy.

FIG. 5 is a process flow diagram of a method for performing sonic logging in a wellbore.

FIGS. 6A and 6B illustrate the physical representations used for the calculations.

FIGS. 7A and 7B illustrate the performance of the acoustic metamaterial for the amplification of a quadrupole source.

FIGS. 8A and 8B illustrate the performance of the acoustic metamaterial for the application of a dipole source.

### DETAILED DESCRIPTION

Measurement of the shear velocity of geologic formations is increasingly utilized in converted seismic wave imaging. Enhancing the surface seismic shear velocity model with wellbore seismic, or sonic, logging data would improve the calibration of earth models in reservoir characterization. This is especially true in desert environments, where attenuation due to weathering of subsurface layers that include sand has an adverse effect on the signal-to-noise-ratio (SNR) of seismic data. As described herein, existing wellbore acoustic logging systems lack of sufficient radiation energy from acoustic sources in the low frequency range (<2 kHz) to characterize the geology far from the wellbore, such as about 100 m, about 50 m, about 20 m, or about 10 m.

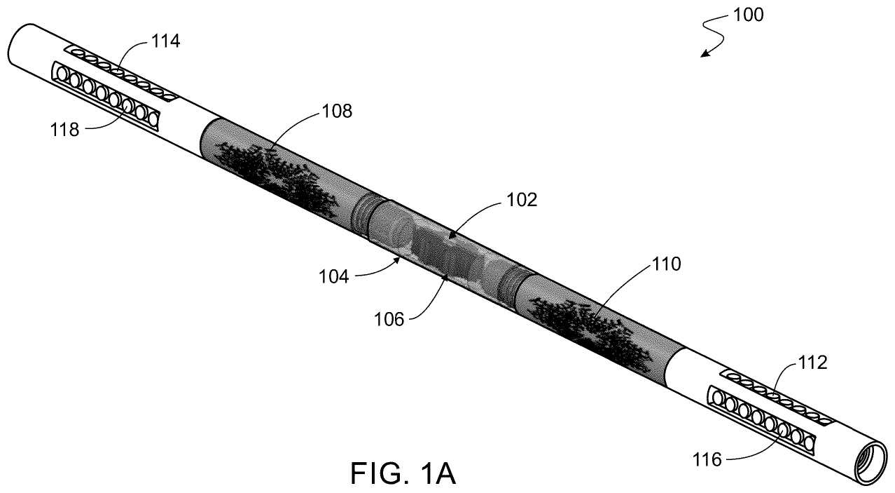

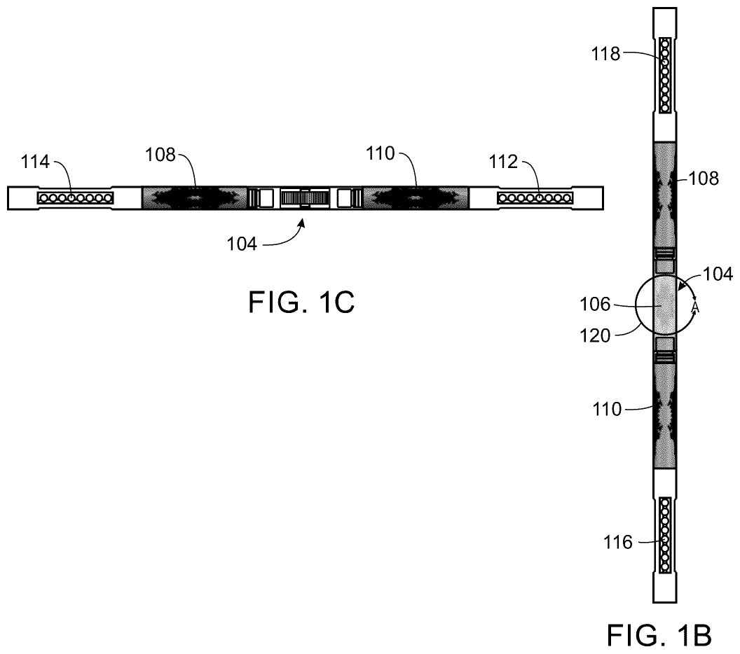

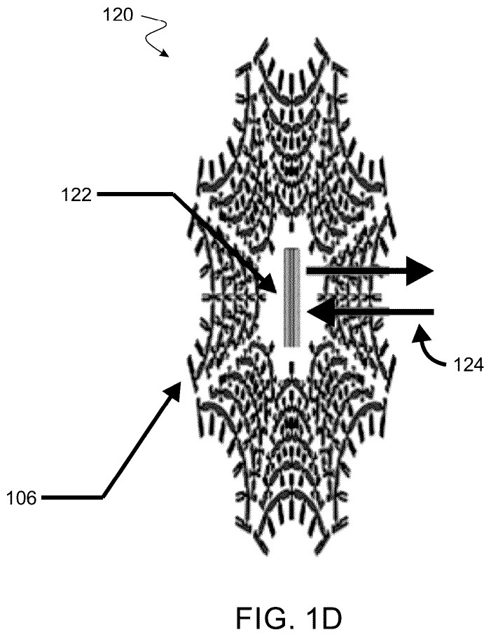

FIGS. 1A-1D are drawings of a sonic logging tool 100 using a dipole source 102. Although this example is directed to a dipole source 102, it can be understood that other sources, such as a quadrupole source, may be used in the sonic logging tool 100.

FIG. 1A is a perspective drawing of the sonic logging tool 100. The sonic logging tool 100 has an acoustic source 104 that includes a metamaterial lens 106 with the dipole source 102 placed within the metamaterial lens 106, for example, near the center. In some embodiments, the dipole source 102 is a piezoelectric bender plate that is powered by an oscillating current sent to the excitation frequency, emitting sonic energy. The metamaterial lens 106 amplifies the sonic energy and directs it outside of the sonic logging tool 100 through any well tubulars, and into the materials, or layers, of the subsurface around the wellbore, for example, rock formations, sand layers, oil containing layers, gas containing layers, water containing layers, and the like.

The signal-to-noise ratio (SNR) of the sonic logging tool 100 can be improved by limiting the amount of sonic energy that is directly conveyed from the acoustic source 104 to detectors along the axis of the sonic logging tool 100. In some embodiments, this is performed by placing energy absorbers in the sonic logging tool 100, for example, on each side of the acoustic source 104.

The sonic energy that is directed into the materials of the subsurface reflects off of the materials of the subsurface around the wellbore and can be detected by the sonic logging tool. In some embodiments, this is performed by detectors that are incorporated into the sonic logging tool opposite each of the metamaterial elastic energy absorber 108 and 110 from the acoustic source 104. The detectors can include a cross-line acoustic receiver array 112 and 114 and an in-line acoustic receiver array 116 and 118. Each array includes a number of detectors sensitive to the frequency of the sonic energy. The cross-line acoustic receiver array 112 or 114 is placed perpendicular to the plane of the metamaterial lens 106 while the in-line acoustic receiver array 116 and 118 is placed in the same plane as the metamaterial lens 106. This improves the analysis of reflections from subsurface structures, such as faults, which may not be in the plane of the emitted sonic energy and allows determination of the azimuthal location of the reflector.

FIG. 1B is a side view of the sonic logging tool 100 in the plane of the metamaterial lens 106 in the acoustic source 104. As shown in FIG. 1B, each in-line acoustic receiver array 116 and 118 is in the same plane as the metamaterial lens 106. A close-up view 120 of the acoustic source 104 is shown in further detail in FIG. 1D.

FIG. 1C is a side view of the sonic logging tool 100 perpendicular to the plane of the metamaterial lens 106 in the acoustic source 104. As shown in FIG. 1C, each cross-line acoustic receiver array 112 and 114 is perpendicular to the plane as the metamaterial lens 106.

FIG. 1D is a close-up view 120 of the metamaterial lens 106 showing the positioning of the dipole source 122 in the center of the metamaterial lens 106. As described herein, the dipole source 122 is a piezo bender plate source. The oscillatory lateral motion 124 of the piezo bender plate generates sonic energy in a dipole radiation pattern from the center of the metamaterial.

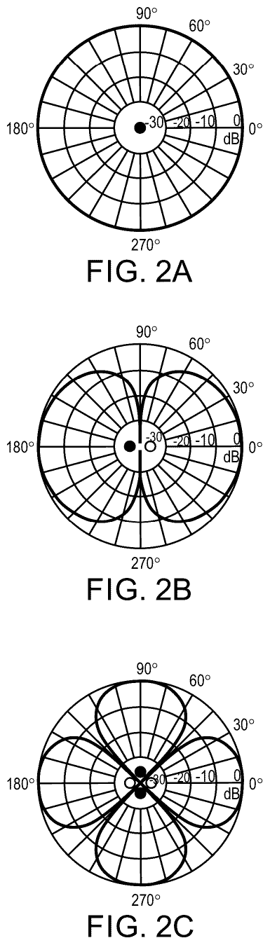

FIGS. 2A-2C are plots of acoustic source radiation patterns that can be created in examples described herein. These include monopole, dipole, and quadrupole acoustic measurements. FIG. 2A is a plot of a monopole radiation pattern. Monopole methods have been successfully deployed using high frequency sources (10-12 kHz) for near wellbore measurements.

FIG. 2B is a plot of a dipole radiation pattern. Dipole acoustic logging methods have been deployed using mid-frequency sources (3-5 kHz) for characterizing formation characteristics within about 150 feet (about 50 m) from the wellbore by inducing flexural wave motion in the formation. However, in previous methods, the dipole acoustic method has had a high amplitude tool body wave that contaminated the signal at the receiver array, lowering the SNR. Accordingly, a simple increase in the power to the acoustic source will increase the effect of the tool body wave on the SNR. This prevents the use of a power increase to improve the depth of investigation of the dipole sources currently used. Thus, the metamaterial lens used in the sonic logging tool 100 may circumvent this limitation, as there is a much more highly efficient conversion of mechanical energy into acoustic radiation with the metamaterial lens.

FIG. 2C is a plot of a quadrupole radiation pattern. Quadrupole acoustic waves are an alternative technique for characterizing materials in the subsurface, such as a formation. The quadrupole acoustic wave induces shear waves into the formation in a 3D bi-conical shape. It will provide additional data available on formation properties if used in conjunction with dipole logging. Further, at low frequencies the tool body wave for quadrupole acoustic waves is low in comparison to the monopole and dipole tool body modes. Consequently, the SNR that can be achieved with a quadrupole method is higher than both monopole and dipole methods, assuming the radiated acoustic power can be amplified significantly.

Thus, there is an advantage to using a sonic logging tool that includes both quadrupole and dipole acoustic sources for formation characterization at far distances from the wellbore. The acoustic metamaterial described herein is capable of amplifying the both the quadrupole and dipole sources radiation deep into the far field. This enables imaging of geologies within the low frequency acoustics range compatible with wellbore seismic.

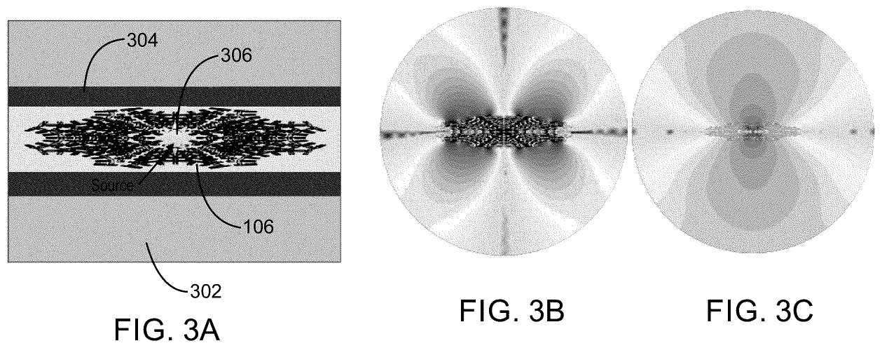

FIGS. 3A-3C are illustrations of the sonic logging tool showing quadrupole and dipole acoustic radiation patterns to image materials, such as a formation 302, outside of a wellbore. Like numbered items are as described with respect to FIGS. 1A-1D. FIG. 3A is a drawing of an acoustic metamaterial amplification lens immersed in a wellbore fluid 304 with an acoustic source 306 that is a quadrupole acoustic source or a dipole acoustic source embedded within the interior of the metamaterial lens 106. FIG. 3B is a plot of an acoustic radiation pattern of quadrupole source amplification from the metamaterial. FIG. 3C is a plot of an acoustic radiation pattern of dipole source amplification. The metamaterial lens 106 was found to enhance radiated acoustic power by more than 100× over certain frequency bandwidths when operated in fluid media such as a wellbore fluid 302.

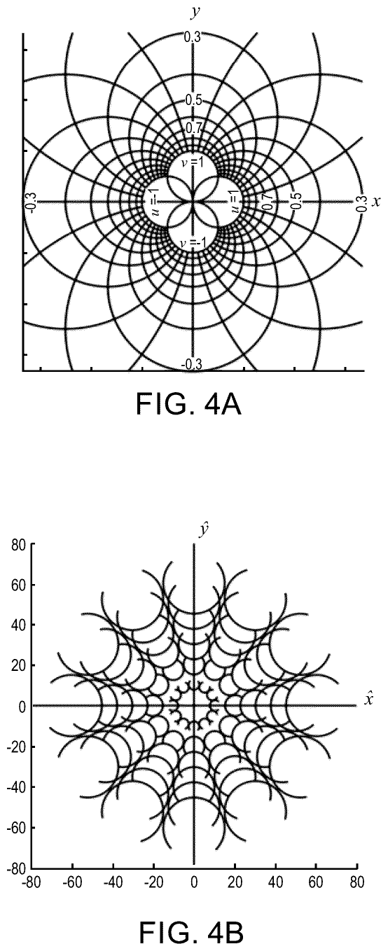

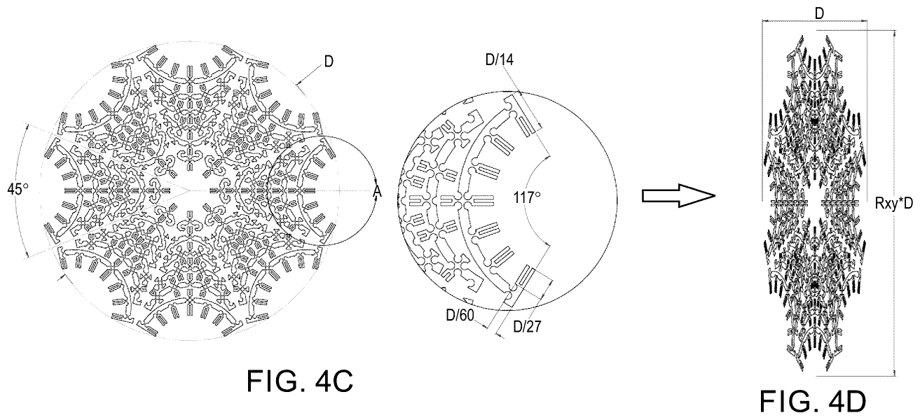

FIGS. 4A-4D are plots of geometric inversions of Tangent Circles conformal mapping contours that is used to develop metamaterials that have a strong interaction with acoustic waves. This allows the development of a geometry for acoustic media that leads to order of magnitude amplification of acoustic radiation in downhole fluids over multiple broad bandwidths from 1-3 kHz.

FIG. 4A is a plot of the reference conformal mapping contours. The geometry derivation first considers the conformal mapping from Cartesian coordinate space to a new virtual domain described by the relations:

$$x = \frac{u}{{u}^{2} + {v}^{2}} \qquad eq . ( 1 )$$

$$y = \frac{v}{{u}^{2} + {v}^{2}} \qquad eq . ( 2 )$$

which is illustrated graphically in FIG. 4A. A geometric inversion of the conformal contours can be accomplished using the relations:

$$\hat{x} = \frac{- [ {u}^{2} + 2 {v}^{2} ]}{{u}^{3} + u {v}^{2}} \qquad eq . ( 3 )$$

$$\hat{y} = \frac{v}{{u}^{2} + {v}^{2}} \qquad eq . ( 4 )$$

FIG. 4B is a plot of the geometric inversion of reference conformal contours. The geometry transformation results in a set of non-conformal contours that in effect ‘invert’ the original conformal mapping geometry from inside-out as illustrated in FIG. 4B, into a tentacle-type set of truncated contours, which can then be used to generate a plan for the acoustic metamaterial.

FIG. 4C is a drawing of the acoustic metamaterial formed along the inverted contours. In an embodiment, the metamaterial pattern is generated from a seed pattern of six nearly evenly distributed radially spaced contours containing seven nearly evenly spaced angular resonators along the outermost contour. The number of resonators along each of the radially spaced contours is decreased proportionately with the radial distance of the contour from the center of the cell, in order to create a staggered angular alignment of resonators between successive contours. The design is not limited to this approach, as other techniques can be used with this inverted geometry to achieve acoustic amplification. The resulting geometry creates a two-dimensional array of elastodynamic resonators in the metamaterial which manipulates acoustic waves within a subwavelength distance between the resonators, each also smaller than the wavelength scale. This phenomenon is enabled by the generation of multiple local modes within the metamaterial cell leading to the superposition of strong phase manipulating resonances for amplification of multipole radiation.

FIG. 4D is a drawing of the final metamaterial showing the anisotropy of the acoustic metamaterial of the cell with a detail of an anisotropic scaling depicted in the lower right. The anisotropy of the acoustic metamaterial amplifies sound energy outward from the axis of the sonic logging tool, decreasing the amount of sound energy that is amplified along the axis of the sonic logging tool in the direction of the acoustic detectors. Additionally, the frequency at which amplification of dipole and/or quadrupole emission is created can be modified by simply changing the cell size D and/or anisotropy scaling factor R_{xy}. Thereby, acoustic amplification can be optimized for specific frequencies and frequency bandwidths by parametrically deducing from analysis the appropriate combinations of cell size and anisotropy scaling factor R_{xy}.

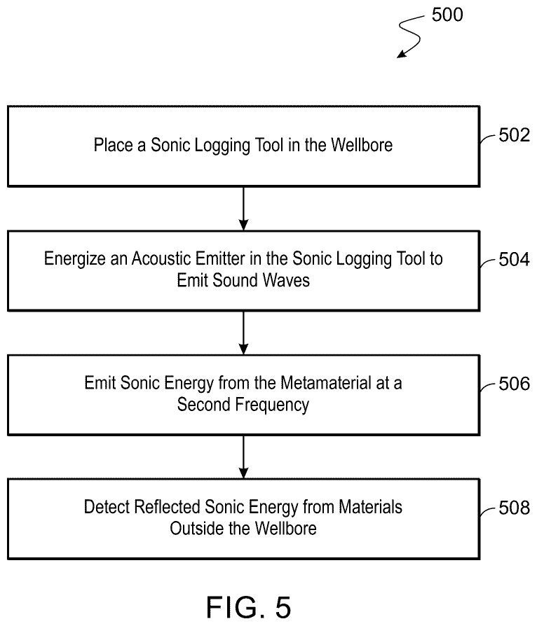

FIG. 5 is a process flow diagram of a method 500 for performing sonic logging in a wellbore. The method begins at block 502, when a sonic logging tool is placed in the wellbore. The sonic logging tool includes an acoustic source and an acoustic detector. The acoustic source includes an acoustic metamaterial, and an acoustic emitter disposed in the center of the acoustic metamaterial. In various embodiments, the acoustic emitter is a piezoelectric dipole source or a piezoelectric quadrupole source.

At block 504, the acoustic emitter is energized to emit soundwaves. This can be performed by powering the piezoelectric acoustic emitter with an oscillating power supply, which oscillates in response, emitting the soundwaves. A dipole source will include a single centralized piezoelectric bender bar, while a quadrupole source will include four radially symmetric piezoelectric bender bars.

At block 506, the sonic energy from the piezoelectric acoustic emitter is amplified by the metamaterial. The amplified sonic energy is directed perpendicular to the axis of the sonic logging tool into the materials outside the wellbore, such as the rock layers of a reservoir. The sonic energy reflects off the materials outside the wellbore and is directed back towards the sonic logging tool.

At block 508, the reflected sonic energy is detected by acoustic detectors on the sonic logging tool. The acoustic detector can include a cross-line acoustic receiver array, an in-line acoustic receiver array, or a combination thereof. The cross-line acoustic receiver array is disposed at a 90° angle from the plane of the acoustic metamaterial, while the in-line acoustic receiver array is disposed in the same plane as the acoustic metamaterial. The difference between the cross-line acoustic receiver array and the in-line acoustic receiver array may allow the detection of reflections from structures in the materials outside the wellbore, such as faults, composition changes, liquid content changes, gas content changes, and the like.

### EXAMPLES

### Model Development

The geometry was investigated through modeling with finite element analysis to characterize the acoustic radiation amplification properties for various cell sizes and geometric anisotropy factors Rxy. The acoustic amplification spectra were calculated from a 2D acoustic structural interaction simulations using the MultiPhysics 5.6 finite element analysis software package, commercially available from Comsol®.

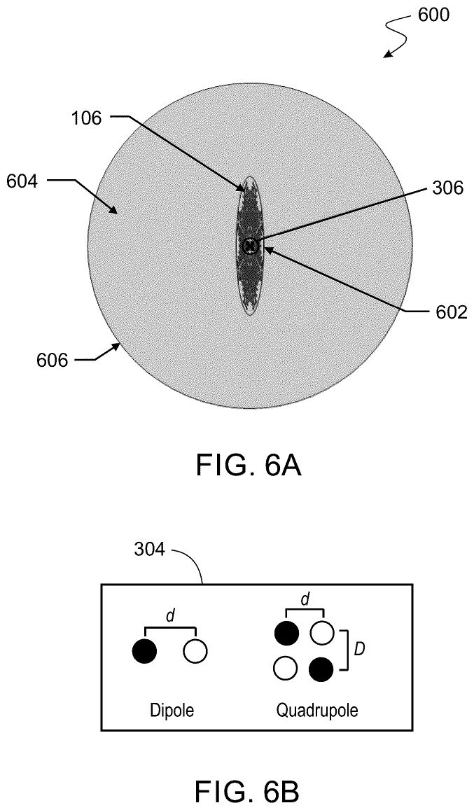

FIGS. 6A and 6B illustrate the physical representations used for the calculations. Like numbered items are as described with respect to previous figures. FIG. 6A is a drawing of the model 600 used in the calculation. The model is based on a solid material pattern for the acoustic metamaterial used for the metamaterial lens 106, which is extruded perpendicular to the plane of analysis in a thermoviscous fluid medium 602. An acoustic fluid 604 surrounds the thermoviscous fluid medium 602, with a non-reflecting acoustic boundary 606 surrounding the acoustic fluid 604. The maximum element size in the mesh is approximately λ/1000 in order to accurately capture the details of the subcell geometry.

FIG. 6B is a drawing of the acoustic emitters 306 that are used in the modelling. The dipole and quadrupole acoustic source models were constructed using alternating polarity monopole point sources as illustrated in FIG. 6B.

The geometric parameters d and D affect the strength of the two sources. For the dipole source, the paramater d is the separation distance between opposite polarity monopoles in the pressure amplitude relationship:

$$\vert {p}_{d} ( r , θ , t ) \vert = \frac{Q ρ {ck}^{2} d}{4 π r} cos ( θ ) \qquad eqn . ( 5 )$$

For the quadrupole source, D is the separation distance between dipole sources:

$$\vert {p}_{q} ( r , θ , t ) \vert = \frac{Q ρ {ck}^{3} dD}{π r} cos ( θ ) sin ( θ ) \qquad eqn . ( 6 )$$

where Q is the complex source strength, related to the volume of fluid displaced by the source, which is proportional to the product of the source surface area and surface velocity.

Intrinsic solid material damping was modeled as frequency dependent isotropic loss factor described by:

$$ζ = \frac{{f}_{1} {f}_{2}}{{f}_{1} - {f}_{2}} [ \frac{{η}_{1} {f}_{1} - {η}_{2} {f}_{2}}{{f}_{1} {f}_{2}} - \frac{{η}_{1} - {η}_{2}}{f} ] \qquad eqn . ( 7 )$$

where η₁=0.02, η₂=0.002, f₁=500 Hz, f₂=10000 Hz, and f is frequency in Hz. The fluid medium in the analyses was modeled as a viscous liquid to account for losses associated with interfacial shear stresses developed at the structural-fluid boundaries.

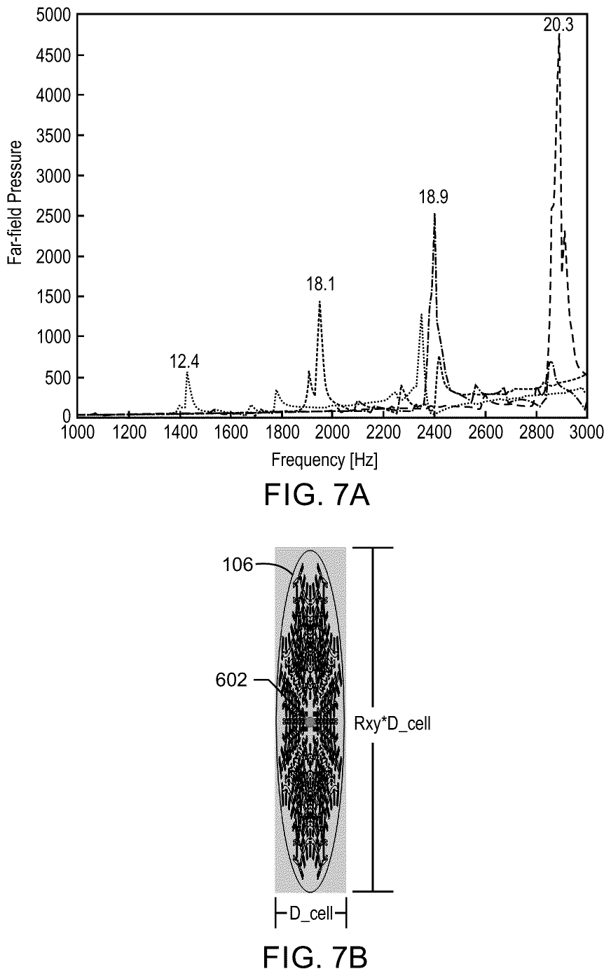

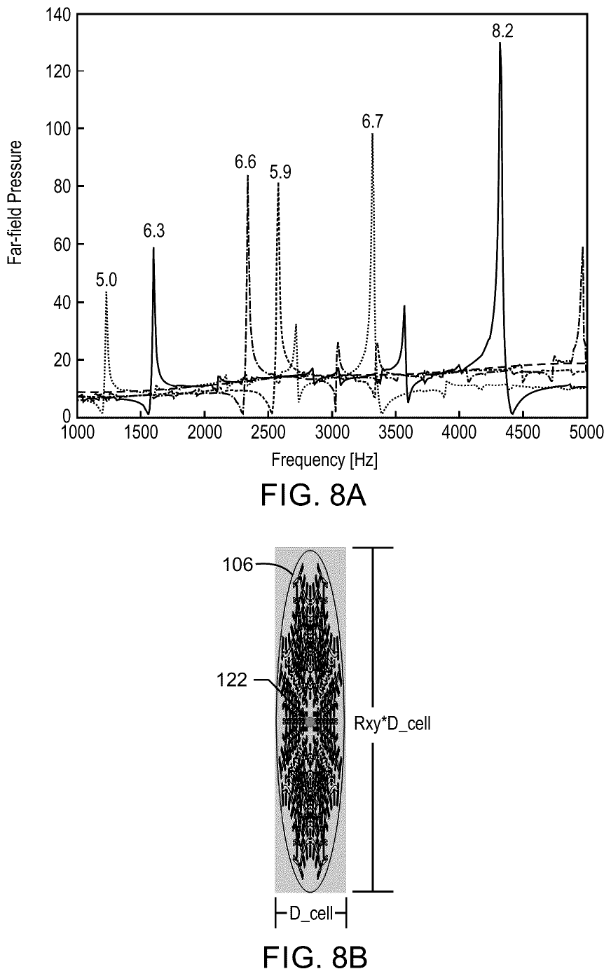

The results from the model using the quadrupole source are discussed with respect to FIGS. 7A and 7B. The results from the model using the dipole source discussed with respect to FIGS. 8A and 8B.

### Results

FIGS. 7A and 7B illustrate the performance of the acoustic metamaterial for the amplification of a quadrupole source. Like numbered items are as described with respect to previous figures. The size and performance of the acoustic metamaterial are shown in Table 1. FIG. 7A is a plot showing amplification of quadrupole acoustic emission using the metamaterial lens 106 at each of the four anisotropy configurations shown in Table 1. FIG. 7B is a drawing of the metamaterial lens 106 with the dipole source 122 placed in the center.

TABLE 1
pressure amplification of quadrupole acoustic emission using an
acoustic metamaterial lens (cell dimensions are in meters).

| D_cell | Rxy | Amplification | Frequency (kHz) |
|---|---|---|---|
| 0.1150 | 4.0000 | 12.4020 | 1.4300 |
| 0.0850 | 4.0000 | 18.0952 | 1.9500 |
| 0.0900 | 3.5000 | 18.9667 | 2.4000 |
| 0.0750 | 3.5000 | 20.2838 | 2.8900 |

The results indicate that the metamaterial lens 106 is adaptable for specific ranges of quadrupole logging frequency with changes in cell size ‘D’ and/or anisotropy scaling factor ‘Rxy’. Since radiated acoustic power is proportional to the square of the pressure amplitude, the values in the listing in Table 1 indicate a power amplification factor in excess of 100×.

FIGS. 8A and 8B illustrate the performance of the acoustic metamaterial for the application of a dipole source. Like numbered items are as described with respect to previous figures. The configuration and performance of the acoustic metamaterial are shown in Table 2. FIG. 8A is a plot showing amplification of dipole acoustic emission using the metamaterial lens 106 at each of the five anisotropy configurations shown. FIG. 8B is a drawing of the metamaterial lens 106 with the dipole source 122 placed in the center.

TABLE 2
pressure application of dipole acoustic emission using an
acoustic metamaterial lens (cell dimensions are in meters).

| D_cell | Rxy | Amplification | Frequency (kHz) |
|---|---|---|---|
| 0.0650 | 5.0000 | 5.0228 | 1.2300 |
| 0.0500 | 5.0000 | 6.3367 | 1.6000 |
| 0.0550 | 4.0000 | 6.5761 | 2.3400 |
| 0.0500 | 4.0000 | 5.8711 | 2.5800 |
| 0.0650 | 5.0000 | 6.7274 | 3.3200 |

As can be seen, the metamaterial lens 106 is adaptable for ranges of dipole logging frequency with change in cell size ‘D’ and/or anisotropy scaling factor ‘Rxy’ with a power amplification factor in excess of 40X for dipole emission.

### EMBODIMENTS

An embodiment described herein provides a sonic logging tool. The sonic logging tool includes an acoustic source that includes an acoustic metamaterial and an acoustic emitter disposed in the center of the metamaterial. The sonic logging tool further includes an acoustic detector that includes a cross-line acoustic receiver array and an in-line acoustic receiver array.

In an aspect, combinable with any other aspect, the sonic logging tool includes a metamaterial elastic energy absorber disposed between the acoustic source and the acoustic detector.

In an aspect, combinable with any other aspect, the acoustic metamaterial includes a geometric patterned surface based on a geometrical inversion of a Tangent Circles conformal mapping contours.

In an aspect, combinable with any other aspect, the acoustic emitter includes a piezoelectric transducer.

In an aspect, combinable with any other aspect, the acoustic emitter includes an oscillating power supply to power the piezoelectric transducer.

In an aspect, the acoustic emitter includes a dipole source. In an aspect, the acoustic emitter includes a quadrupole source. In an aspect, the acoustic emitter includes two acoustic sources, wherein a first acoustic source includes a dipole source and a second acoustic source includes a quadrupole source.

In an aspect, combinable with any other aspect, the acoustic source is disposed in an acoustic fluid.

In an aspect, combinable with any other aspect, the acoustic source is disposed in a center section of the sonic logging tool, with two metamaterial elastic energy absorbers disposed in the sonic logging tool, one above and one below the acoustic source, and two acoustic detectors disposed on an opposite side of each of the two metamaterial elastic energy absorbers from the acoustic source.

Another embodiment described herein provides a method for performing sonic logging in a wellbore. The method includes placing a sonic logging tool in the wellbore. The sonic logging tool includes an acoustic source that includes an acoustic metamaterial and an acoustic emitter disposed in the center of the metamaterial. The sonic logging tool further includes an acoustic detector that includes a cross-line acoustic receiver array and an in-line acoustic receiver array. The acoustic emitter is energized to emit sound waves and amplified sonic energy is emitted from the metamaterial. Reflected sonic energy from materials outside the wellbore is detected.

In an aspect, combinable with any other aspect, energizing the acoustic emitter includes powering a dipole source.

In an aspect, combinable with any other aspect, energizing the acoustic emitter includes powering a quadrupole source.

In an aspect, combinable with any other aspect, the method includes detecting the reflected sonic energy with an in-line receiver array.

In an aspect, combinable with any other aspect, the method includes detecting the reflected sonic energy with a cross-line receiver array.

In an aspect, combinable with any other aspect, the method includes absorbing acoustic energy in the sonic logging tool with an acoustic metamaterial placed between the acoustic source and the acoustic detector in the sonic logging tool.

In an aspect, combinable with any other aspect, the method includes energizing a first acoustic source including a dipole source and a second acoustic source including a quadrupole source.

Another embodiment described herein provides an acoustic source. The acoustic source includes an acoustic metamaterial generated from a geometrical inversion of a set of conformal contours developed from mapping of Tangent Circles, wherein the acoustic metamaterial is anistotropic with a horizontal axis (D_cell) smaller than a vertical axis (R_{xy}*D_cell).

In an aspect, combinable with any other aspect, an anisotropic scaling factor (R_{xy}) of the horizontal axis to the vertical axis is between about 3.5 and about 5.

In an aspect, combinable with any other aspect, the acoustic source includes an acoustic emitter disposed in the center of the acoustic metamaterial.

In an aspect, combinable with any other aspect, the acoustic emitter includes a quadrupole source, and wherein the acoustic metamaterial has a power amplification factor for sonic energy from the acoustic source of greater than 100×.

In an aspect, combinable with any other aspect, the acoustic emitter includes a dipole source, and wherein the acoustic metamaterial has a power amplification factor for sonic energy from the acoustic source of greater than 40×.

Other implementations are also within the scope of the following claims.

What is claimed is:

1. A sonic logging tool, comprising:
an acoustic source, comprising:
an acoustic metamaterial; and
an acoustic emitter disposed in the center of the metamaterial; and
an acoustic detector, comprising:
a cross-line acoustic receiver array; and
an in-line acoustic receiver array.

2. The sonic logging tool of claim 1, comprising a metamaterial elastic energy absorber disposed between the acoustic source and the acoustic detector.

3. The sonic logging tool of claim 1, wherein the acoustic metamaterial comprises a geometric patterned surface based on a geometrical inversion of a Tangent Circles conformal mapping contours.

4. The sonic logging tool of claim 1, wherein the acoustic emitter comprises a piezoelectric transducer.

5. The sonic logging tool of claim 4, wherein the acoustic emitter comprises an oscillating power supply to power the piezoelectric transducer.

6. The sonic logging tool of claim 1, wherein the acoustic emitter comprises a dipole source.

7. The sonic logging tool of claim 1, wherein the acoustic emitter comprises a quadrupole source.

8. The sonic logging tool of claim 1, comprising two acoustic sources, wherein a first acoustic source comprises a dipole source and a second acoustic source comprises a quadrupole source.

9. The sonic logging tool of claim 1, wherein the acoustic source is disposed in an acoustic fluid.

10. The sonic logging tool of claim 1, wherein the acoustic source is disposed in a center section of the sonic logging tool, with two metamaterial elastic energy absorbers disposed in the sonic logging tool, one above and one below the acoustic source, and two acoustic detectors disposed on an opposite side of each of the two metamaterial elastic energy absorbers from the acoustic source.

11. A method for performing sonic logging in a wellbore, comprising:
placing a sonic logging tool in the wellbore, wherein the sonic logging tool comprises:
an acoustic source, comprising:
an acoustic metamaterial; and
an acoustic emitter disposed in a center of the acoustic metamaterial; and
an acoustic detector, comprising:
a cross-line acoustic receiver array; and
an in-line acoustic receiver array; and
energizing the acoustic emitter to emit sound waves;
emitting amplified sonic energy from the metamaterial; and
detecting reflected sonic energy from materials outside the wellbore.

12. The method of claim 11, wherein energizing the acoustic emitter comprises powering a dipole source.

13. The method of claim 11, wherein energizing the acoustic emitter comprises powering a quadrupole source.

14. The method of claim 11, comprising detecting the reflected sonic energy with an in-line receiver array.

15. The method of claim 11, comprising detecting the reflected sonic energy with a cross-line receiver array.

16. The method of claim 11, comprising absorbing acoustic energy in the sonic logging tool with an acoustic metamaterial placed between the acoustic source and the acoustic detector in the sonic logging tool.

17. The method of claim 11, comprising energizing a first acoustic source comprising a dipole source and a second acoustic source comprising a quadrupole source.

18. An acoustic source, comprising an acoustic metamaterial generated from a geometrical inversion of a set of conformal contours developed from mapping of Tangent Circles, wherein the acoustic metamaterial is anistotropic with a horizontal axis (D_cell) smaller than a vertical axis (R_{xy}*D_cell).

19. The acoustic source of claim 18, wherein an anisotropic scaling factor (Rxy) of the horizontal axis to the vertical axis is between about 3.5 and about 5.

20. The acoustic source of claim 18, comprising an acoustic emitter disposed in the center of the acoustic metamaterial.

21. The acoustic source of claim 20, wherein the acoustic emitter comprises a quadrupole source, and wherein the acoustic metamaterial has a power amplification factor for sonic energy from the acoustic source of greater than 100×.

22. The acoustic source of claim 20, wherein the acoustic emitter comprises a dipole source, and wherein the acoustic metamaterial has a power amplification factor for sonic energy from the acoustic source of greater than 40×.
